(19) United States
(12) Patent Application Publication
(10) Pub. No.: US 2016/0134652 A1
(43) Pub. Date: May 12, 2016

(54) METHOD FOR RECOGNIZING DISGUISED MALICIOUS DOCUMENT

(71) Applicant: Verint Systems Ltd., Herzliya (IL)

(72) Inventors: Ming-Chang Chiu, Taipei City (TW); Ming-Wei Wu, Taipei City (TW); Ching-Chung Wang, Taipei City (TW); Che-Kuo Hsu, Taipei City (TW); Pei-Kan Tsung, Taipei City (TW)

(21) Appl. No.: 14/997,909

(22) Filed: Jan. 18, 2016

Related U.S. Application Data
(63) Continuation-in-part of application No. 14/167,151, filed on Jan. 29, 2014.

(51) Int. Cl. H04L 29/06; G06F 21/56

(52) U.S. Cl. CPC H04L 63/1425; G06F 21/562; G06F 2221/034

(57) ABSTRACT

A method for recognizing disguised malicious document, carried out by a computer system including a central processing unit (CPU), a memory, and a database storing rules for defining executable file and non-executable file, comprising steps of: receiving a static file through a network and an input/out interface; scanning the static file for a file header to determine if it is a non-executable file; analyzing file body of the non-executable file to locate components of an executable file and mark these positions; extracting components of the executable file from the non-executable file; concatenating the extracted components in accordance with a default rule or a heuristic rule to form a new file; and obtaining a new file that is executable, such that the received static file is a non-executable file having an embedded executable file, thus labeling the static file as a disguised malicious document.

### RELATED MATTERS

This application is a continuation-in-part (CIP) of a pending application Ser. No. 14/167,151 filed on Jan. 29, 2014, entitled “Method for Recognizing Malicious File”.

### BACKGROUND OF THE INVENTION

1. Field of the Invention

The present invention relates to a method for recognizing documents, and in particular to a method for recognizing disguised malicious document.

2. The Prior Arts

In the Prior Art, malicious file (or malware) may attack computer system through different ways. For example, a malware may be encrypted in several segments embedded and distributed within the code of a normal file, such as doc file, xls file, ppt file, pdf file and etc. For the users, this kind of malicious file is usually considered as a normal file that could be a text document, figure or video file received through Internet or any connected portable device. Once the normal file is executed, the encrypted malware could be executed simultaneously while accessing the operating system to infect the system.

In general, the approach for recognizing the malicious file is to extract multi-segments from the file as a fingerprint or signature of the file. By means of heuristics, the signature of file is then compared with a blacklist established in accordance with publicly known malware codes and stored in a database, so as to determine whether the file has malicious behavior.

Most approaches prevent computer malwares in a passive way that arranges several surveillance gates in the computer system to catch the malware intending to access somewhere in the system. Namely, if the malware invades other location where has no surveillance gate, the system is then infected. If further putting up more surveillance gates in the computer system, the computing burden relatively increases and as well slows down the computation.

To improve the shortcomings of the technology mentioned above, a virtual and dynamic approach is proposed. Wherein, a virtual machine is used to actually run and execute the malicious file, to detect and verify that the suspected malicious file is indeed malicious and harmful. Since the malicious file is run by a separate virtual machine, the computer system (or any other Application Systems) would not be infected by the malicious file. However, the virtual machine required in this approach could incur additional cost.

The approaches mentioned above may recognize the known malicious file encrypted and embedded in a normal file. However, the approach is not effective for the unknown or new malicious file, as there is no record of feature for such new malicious file in the blacklist. Therefore, there is a need of a capability for recognizing and predicting new malicious files, even lacking enough features about the malicious files.

### SUMMARY OF THE INVENTION

In order to overcome the drawbacks of the Prior Art, the present invention provides a method for recognizing disguised malicious document. Wherein, a static approach is adopted to detect the malicious file that is (program) executable (also referred to as an executable file), and a document (file) that is (program) non-executable (also referred to as a non-executable file) containing the embedded malicious file (executable file).

The objective of the present invention is to provide a method for recognizing disguised malicious document, that utilizes a static approach of scanning, analyzing, extracting, concatenating, and confirming steps, to detect and recognize the executable file embedded in a non-executable file, in contrast to the dynamic approach of placing the document in a virtual machine to actually execute the malicious file (executable file) of the Prior Art. In this respect, the document received from Internet and input/output interface can be refereed to as a static file.

In order to achieve the objective mentioned above, the present invention provides a method for recognizing disguised malicious document, utilized in the field of anti-virus software, and is carried out by a computer system including a central processing unit (CPU), a memory for processing a received file, and a database storing rules for defining an executable file and a non-executable file, including following steps:

receiving a static file through a network and an input/output interface, to be stored in the memory;

scanning the static file for a file header to determine if it is a non-executable file, if it is not a non-executable file, then the static file is an executable file; otherwise

analyzing file body of the non-executable file, to locate components of the executable file and mark these positions, if components of the executable file can not be located, then the static file is a safe file; otherwise

extracting the components of the executable file from the non-executable file;

concatenating the extracted components in accordance with a default rule or a heuristic rule to form a new file; and

obtaining a new file that is executable, such that the received static file is the non-executable file having an embedded executable file, thus labeling the static file as a disguised malicious document.

In the scanning the static file step mentioned above, in case the static file scanned is determined as an executable file, then that file is not processed further by the method of the present invention (that file can be processed by an ordinary anti-virus software), since the present invention is designed to specifically deal with the advanced type virus-containing malicious file formed by embedding a (program) executable file into a (program) non-executable document (file).

In the descriptions above, the rules stored in the database for defining the executable file and the non-executable file are file structure and component ordering.

Also, the components of the executable file include a program executive (PE) header, and a multiple of binary segments; while the binary segments are formed by shellcodes or obfuscated codes. And each of the extracted components is formed by a multiple of binary codes.

Moreover, the default rule is a sequential ordering of the marked positions, while the heuristic rule is a defined ordering or a random ordering of the marked positions.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

FIG. 1 is a block diagram of a system for recognizing disguised malicious document according to the present invention; and

FIG. 2 is a flowchart of the steps of a method for recognizing disguised malicious document according to the present invention.

### DETAILED DESCRIPTION OF THE PREFERRED EMBODIMENT

The present invention provides a method for recognizing disguised malicious document. Wherein, a static approach is adopted to detect the malicious file that is (program) executable (also referred to as an executable file), and a document (file) that is (program) non-executable (also referred to as a non-executable file) containing the embedded malicious file (executable file).

In the early stage, the conventional and primitive virus-containing malicious file is formed as a separate and independent file to attack, infect, and paralyze a system, and that is easy to detect and recognize. However, recently, the advanced type virus-containing malicious file is formed embedded, disassembled, distributed, and disguised in a normal, (program) non-executable document (file), and that is quite difficult for the existing anti-virus software to detect. As such, frequently, the system is infected and paralyzed without being noticed until it is too late. Therefore, to redress this problem, the major objective of the present invention is to detect a (program) executable file disguised in a (program) non-executable file. Since in this field of anti-virus software, no one will possibly spend such cost and effort to embed an executable file into a non-executable file, unless for the purpose of creating and realizing a malicious file. As such, for practical purpose, in the present invention, an executable file thus recognized is a malicious file.

As mentioned above, a malicious file (or malware) is formed as a separate and independent file, that is executable; or it can be formed as a file with its components distributed and embedded in a normal file (program non-executable file), that is non-executable. The latter is rather difficult for an ordinary anti-virus software to detect, thus requiring special design and effort to recognize the embedded malicious file. As such, the malicious file is an executable file, the normal file (document) containing the embedded malicious file is a non-executable file, and that is also referred to as a disguised malicious document.

In the descriptions above, the malicious file can hardly be recognized by an anti-virus software because the malicious file is usually disassembled and embedded in parts, including a program executable header (PE header) and at least a segment of shellcode. Thus, for the users, the disguised malicious document looks normal in appearance. For an ordinary anti-virus software, the disguised malicious document may not be recognized prior to the execution. That means, in the prior art, when users receive the disguised malicious document from e-mail transmission or any input device without vigilance, the hidden malicious file is then readily initiated waiting for the users to open the file, to have the chance to infect the system.

The objective of the present invention is to provide method for recognizing disguised malicious document, that utilizes a static approach of scanning, analyzing, extracting, concatenating, and obtaining steps, to detect and recognize the executable file embedded in a non-executable file, in contrast to the dynamic approach of placing the document in a virtual machine to actually execute the malicious file (executable file) of the Prior Art. In this respect, the document received from Internet and input/output interface is treated in a static approach, and thus it can be referred to as a static file.

Therefore, the technical characteristic of the present invention is that, it takes a static approach of utilizing rules of file structure and component ordering to define executable file and non-executable file, such that prior to executing a disguised malicious document, it could take steps of scanning, analyzing, extracting, concatenating, and obtaining, to recognize the embedded malicious file, to prevent the malicious file (an executable file embedded in the disguised malicious document) from accessing the operating system to infect the system. Another advantage of the present invention is that, it is capable of recognizing unknown or new malicious file, that has no record of feature in the blacklist of database for comparison, as such redressing shortcomings of the Prior Art.

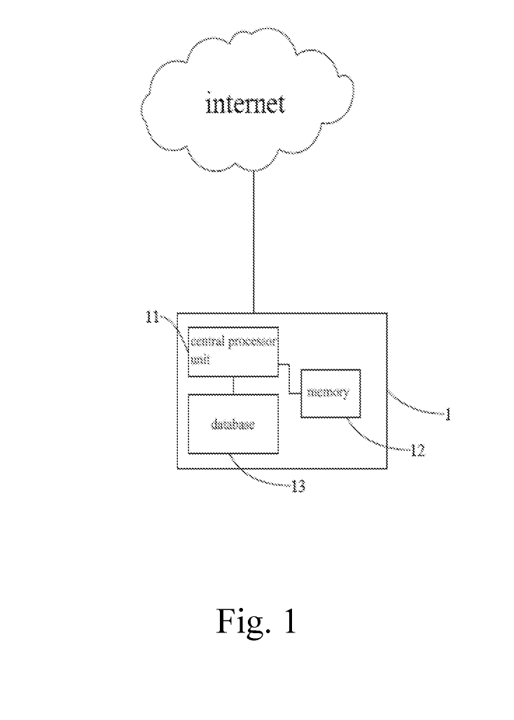

Refer to FIG. 1 for a block diagram of a system for recognizing disguised malicious document according to the present invention. As shown in FIG. 1, the system 1 for recognizing disguised malicious document includes a central processor unit 11 (CPU) for computer program procession and execution, a memory 12 for program storage, and a database 13 for storing rules of file structure and component ordering defining the executable file and the non-executable file. The system 1 could be a user's computer or a network sever, which is capable of receiving documents or files through network transmission, or through an input/output interface coupled to an external device, such as USB flash, disk reader. The memory 12 stores computer programs and files received from the network and the input/output interface.

To be more specific about file structure, each type of file has its unique file structure. File structure is the way data is structured on a disk, and it may also refer to the way data is structured into records and fields within a database. For example, the file structure of a program executable (PE) header may include MS-DOS header, PE signature, image header, and section table. Further, about component ordering, it refers to the sequence of a file structure. For example, the component ordering of a PE file structure is MS-DOS header, PE Signature, image header, section table, and a multiple of binary segments.

Moreover, all the PE files (even 32-bit DLLs) must start with a simple MS-DOS header. DOS MZ header is provided in the case when the program is run from DOS, so DOS is able to recognize it as valid and executable, and it can thus run the DOS stub that is stored next to the MZ header. The DOS stub is actually a valid EXE that is executed in case the operating system does not know about PE file format. It may simply display a string like “This program requires Windows” or it can be a full-blown DOS program depending on the design of the programmer. After MS-DOS header come the PE signature and image header. PE signature and image header are also referred to as PE header. This structure contains many essential fields used by the PE loader. In case the program is executed in the operating system that knows about PE file format, the PE loader can find the starting offset of the PE header from the DOS MZ header. Thus it may skip the DOS stub and go directly to the PE header, that is the real file header. Between the PE header and the raw data of the image's sections lies the section table. The section table contains information about each section in the image. A multiple of binary segments in a PE file are roughly equivalent to a segment containing either code or data.

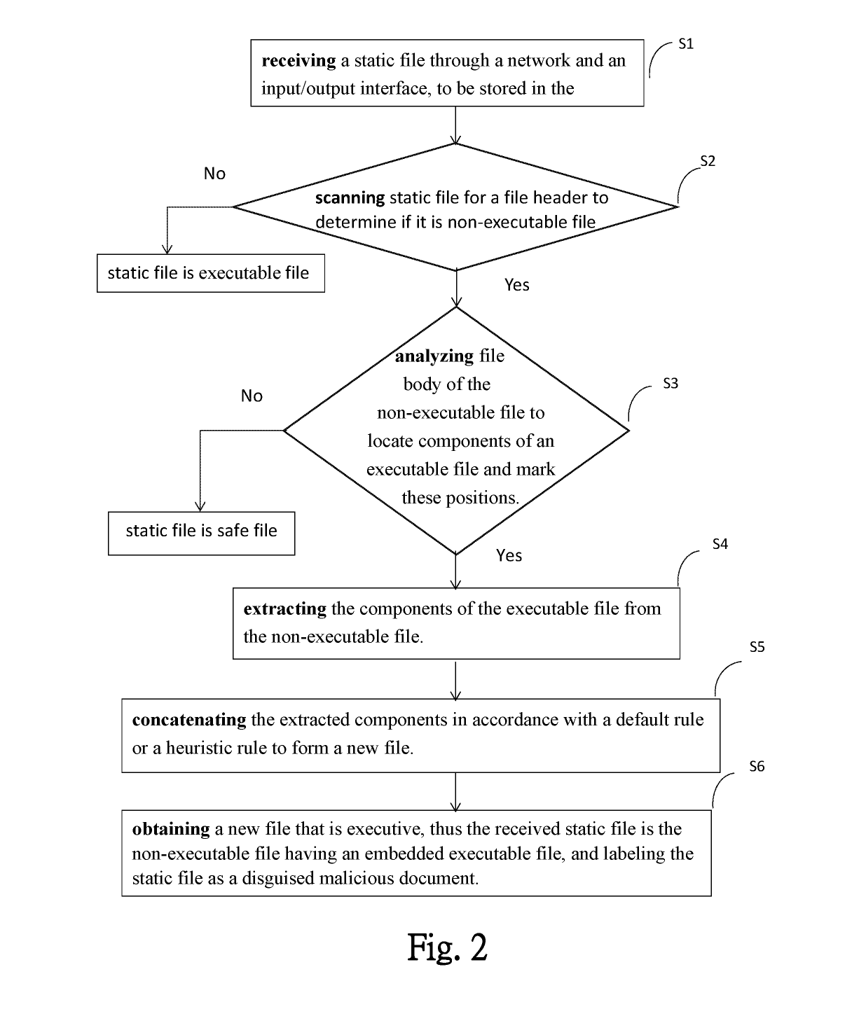

Refer to FIG. 2 for a flowchart of the steps of a method for recognizing disguised malicious document according to the present invention. As shown in FIG. 2, the method for recognizing disguised malicious document is carried out by a computer system 1 including a central processing unit (CPU) 11, a memory 12, and a database 13 storing rules for defining an executable file and a non-executable file, including the following steps:

step S1: receiving a static file through a network and an input/out interface, to be stored in a database 13;

step S2: scanning the static file for a file header to determine if it is a non-executable file, if it is not a non-executable file, then the static file is an executable file; otherwise

step S3: analyzing file body of the non-executable file to locate components of an executable file and mark these positions, if components of the executable file can not be located, then the static file is a safe file; otherwise

step S4: extracting the components of the executable file from the non-executable file;

step S5: concatenating the extracted components in accordance with a default rule or a heuristic rule to form a new file; and

step S6: obtaining a new file that is executable, thus the received static file is a non-executable file having an embedded executable file, and labeling the static file as a disguised malicious document.

It is worth to note that, in the step S2 of scanning the static file mentioned above, in case the static file scanned is determined as an executable file, then that file is not processed further by the method of the present invention (that file can be processed by an ordinary anti-virus software), since the present invention is designed to specifically deal with the advanced type virus-containing malicious file formed by embedding a (program) executable file into a (program) non-executable document (file).

In the step S2 mentioned above, when a static file is received and stored in the memory 12, the CPU 11 automatically starts analyzing the file without any execution. In the step S4, extracting the components of the executable file is performed in segments, with each of the segments a multiple of binary (32 bytes, 64 bytes, 256 bytes or etc.) depending on CPU capability. In the step S6, an executable new file can be found by checking whether each of all the concatenating possibilities is executable. And if it is so, it is recognized as malware.

In general, for a file to be qualified as an executable file, it has to fulfill all the following three conditions. Firstly, the file has to match the file structure of executable files stored in database 13. Secondly, the file has to match the component ordering of executable files stored in database 13. Thirdly, the file has to begin with the file structure of executable files. As such, if a file matches all of these conditions, the file is determined as an executable file; otherwise, the file is determined as a non-executable file.

In the descriptions above, the rules stored in the database 13 for defining the executable file and the non-executable file are file structure and component ordering. In the present invention, since file structure and component ordering are used to define the related files, while file contents are not used for comparison, as such no decryption of files are required.

Also, the components of the executable file include a program executive (PE) header, and a multiple of binary segments; while the binary segments are formed by shellcodes or obfuscated codes. And each of the extracted components is formed by a multiple of binary codes.

Moreover, the default rule is a sequential ordering of the marked positions, while the heuristic rule is a defined ordering or a random ordering of the marked positions. In other words, the marked positions are determined by locating the components of an executable file in a non-executable file, and in case the marked positions of the file are placed in sequence, they are defined according to the default rule. Otherwise, in case the marked positions of the file are not placed in sequence, but it matches the file structure of an executable file after concatenating, they are defined according to the heuristic rule.

Summing up the above, compared with the Prior Art, the present invention has the following advantages: firstly, it takes a static approach of utilizing rules of file structure and component ordering to define executable file and non-executable file, such that prior to executing a disguised malicious document, it could take steps to recognize the embedded malware, to prevent the malware (an executable file embedded in the disguised malicious document) from accessing the operating system to infect the system. Secondly, the present invention is capable of recognizing unknown or new malware, that has no record of feature in the blacklist of database for comparison, as such redressing shortcomings of the prior art. Thirdly, the present invention is capable of recognizing disguised malicious document without using a virtual machine, thus achieving saving of cost and space.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A method for recognizing disguised malicious document, carried out by a computer system including a central processing unit (CPU), a memory, and a database storing rules for defining an executable file and a non-executable file, comprising steps of:
receiving a static file through a network and an input/out interface, to be stored in the database;
scanning the static file for a file header to determine if it is a non-executable file, if it is not a non-executable file, then the static file is the executable file; otherwise
analyzing file body of the non-executable file to locate components of an executable file and mark these positions, if components of the executable file are not located, then the static file is a safe file; otherwise
extracting the components of the executable file from the non-executable file;
concatenating the extracted components in accordance with a default rule or a heuristic rule to form a new file; and
obtaining a new file that is executable, such that the received static file is the non-executable file having an embedded executable file, thus labeling the static file as the disguised malicious document.

2. The method for recognizing disguised malicious document as claimed in claim 1, wherein the rules for defining the executable file and the non-executable file stored in the database are file structure and component ordering.

3. The method for recognizing disguised malicious document as claimed in claim 2, wherein in case the static file matches the rules of file structure and component ordering in the database, and the static file begins with the file structure of executable files, then it is determined as the executable file; otherwise it is determined as the non-executable file.

4. The method for recognizing disguised malicious document as claimed in claim 1, wherein the components of the executable file include a program executable (PE) header, and a multiple of binary segments.

5. The method for recognizing disguised malicious document as claimed in claim 1, wherein the default rule is sequential ordering of the marked positions, while the marked positions are determined by locating the components of the executable file in the non-executable file, and in case the marked positions of the file are placed in sequence, they are defined according to the default rule.

6. The method for recognizing disguised malicious document as claimed in claim 1, wherein the heuristic rule is a defined ordering or a random ordering of the marked positions, while the marked positions are determined by locating components of the executable file in the non-executable file, and in case the marked positions of the file are not placed in sequence, but it matches the file structure of the executable file after concatenating, they are defined according to the heuristic rule.
